(19) United States
(12) Patent Application Publication
(10) Pub. No.: US 2015/0248031 A1
(43) Pub. Date: Sep. 3, 2015

(54) LIGHT DEFLECTION DEVICE AND METHOD FOR DRIVING LIGHT DEFLECTION ELEMENT

(71) Applicant: Sharp Kabushiki Kaisha, Osaka (JP)

(72) Inventors: Yuuichi Kanbayashi, Osaka (JP); Naru Usukura, Osaka (JP); Yasuhiro Sugita, Osaka (JP)

(73) Assignee: SHARP KABUSHIKI KAISHA, Osaka (JP)

(21) Appl. No.: 14/423,983

(22) PCT Filed: Aug. 21, 2013
(86) PCT No.: PCT/JP2013/072263

§ 371 Date: Feb. 25, 2015

(30) Foreign Application Priority Data
Aug. 28, 2012 (JP) 2012-187319

(51) Int. Cl. G02F 1/133; G02F 1/1343

(52) U.S. Cl. CPC G02F 1/13306; G02F 1/13439

(57) ABSTRACT

Provided is a light deflection device that is capable of forming a blazed-type diffraction grating while suppressing an increase in an electrode-applied voltage by using a horizontal electric field mode. A light deflection element is equipped with: a pair of glass substrates; a liquid crystal layer sandwiched between the pair of glass substrates; and a plurality of pattern electrodes arranged over a surface of the glass substrate on the side of the liquid crystal layer, with an interlayer insulation film therebetween. A driving circuit that applies voltages to the light deflection element generates electrode-applied voltages Vpixel so as to change an inter-electrode voltage VLC incrementally in the order of 0V, 3V, and 6V. The electrode-applied voltages Vpixel are a mixture of positive voltages and negative voltages.

### TECHNICAL FIELD

The present invention relates to a light deflection device, and more particularly, to a light deflection device that controls the refractive index of a medium with an anisotropic refractive index by using a so-called horizontal electric field, and a method of driving a light deflection element.

### BACKGROUND ART

In recent years, development has been underway for a light deflection element that uses liquid crystal, which is a medium with an anisotropic refractive index whose refractive index changes due to an electro-optic effect. A light deflection element that uses a liquid crystal is commonly referred to as a “liquid crystal diffraction element.” FIG. 18 is a cross-sectional view showing a configuration of a conventional liquid crystal diffraction element 30. The liquid crystal diffraction element 30 is equipped with: a pair of glass substrates 31a and 31b; a liquid crystal layer 33 sandwiched between the pair of glass substrates 31a and 31b; a plurality of transparent electrodes 32a arranged in a stripe pattern over a surface of the glass substrate 31a on the side of the liquid crystal layer 33 (hereinafter referred to as “pattern electrodes”); and a transparent electrode 32b arranged over an entire surface of the glass substrate 31b on the side of the liquid crystal layer 33 (hereinafter referred to as “common electrode”). Such a liquid crystal diffraction element 30 is described in Patent Document 1, for example. Note that in practice, an interlayer insulation film is provided between the glass substrate 31a and the pattern electrodes 32a and between the glass substrate 31b and the common electrode 32b, and an alignment film is provided on the pattern electrodes 32a. In FIG. 18, however, illustrations of the interlayer insulation films and the alignment film are omitted to achieve consistency with the disclosed contents of Patent Document 1. The liquid crystal diffraction element 30 controls the diffraction angle of incident light by generating an electric field that is perpendicular to the pair of glass substrates 31a and 31b (hereinafter referred to as “vertical electric field”) between the pattern electrodes 32a and the common electrode 32b and thereby changing the refractive index of the liquid crystal layer 33 using a vertical electric field mode. A liquid crystal mode that generates a vertical electric field is commonly referred to as a “vertical electric field mode.”

For the liquid crystal layer 33, a nematic liquid crystal or a ferroelectric liquid crystal with a homogeneous (non-helical) molecular arrangement is used, for example. Examples of the aforementioned vertical electric field mode include ECB (Electrically Controlled Birefringence) and OCB (Optically Compensated Birefringence). More particularly, the liquid crystal diffraction element 30 forms a diffraction grating by applying a prescribed voltage to each of the pattern electrodes 32a and the common electrode 32b and generating a region with a spatial refractive index modulation in the liquid crystal layer 33. Examples of a diffraction grating formed by the liquid crystal diffraction element 30 include a rectangular type, a sinusoidal type, and a blazed type. In a blazed-type diffraction grating, refractive index changes incrementally as well as cyclically. Further, a blazed type is referred to as either a “blazed type” or a “sawtooth type.”

FIG. 19 is a cross-sectional view for describing a relationship between inter-electrode voltage and diffraction grating pattern when a blazed-type diffraction grating is formed in the liquid crystal diffraction element 30 shown in FIG. 18. Note that in a vertical electric field mode, “inter-electrode voltage” refers to a voltage between a pattern electrode and a common electrode. In a horizontal electric field mode to be described later, “inter-electrode voltage” refers to a voltage between adjacent pattern electrodes. For convenience, an X^{th} pattern electrode from the left end of each cross-sectional view (where “X” is an integer of 1 or greater) will be hereinafter referred to as an “X^{th} pattern electrode.” When a blazed-type diffraction grating is formed in a liquid crystal diffraction element, a grating pitch is commonly set to N times the electrode pitch (where N is an integer of 2 or greater).

As shown in FIG. 19, a voltage of 0V is applied to the common electrode 32b. At this time, when voltages of 0V, 5V, 0V, 5V, 0V, and 5V are respectively applied to the first to sixth pattern electrodes 32a, inter-electrode voltages of 0V, 5V, 0V, 5V, 0V, and 5V are respectively generated between the first to sixth electrodes 32a and the common electrode 32b, and an amount of phase modulation (refractive index) corresponding to the respective inter-electrode voltage is obtained. In this manner, a blazed-type diffraction grating with a grating pitch that is twice the electrode pitch (N=2) is formed. Similarly, when voltages of 0V, 2.5V, 5V, 0V, 2.5V, and 5V are respectively applied to the first to sixth pattern electrodes 32a, inter-electrode voltages of 0V, 2.5V, 5V, 0V, 2.5V, and 5V are respectively generated between the first to sixth pattern electrodes 32a and the common electrode 32b, and an amount of phase modulation (refractive index) corresponding to the respective inter-electrode voltage is obtained. In this manner, a blazed-type diffraction grating with a grating pitch that is three times the electrode pitch (N=3) is formed. Here, N represents the size of a grating pitch in relation to the electrode pitch, as well as the number of inter-electrode voltages constituting the combination of inter-electrode voltages that achieves the respective grating pitch (hereinafter referred to as “number of inter-electrode voltages”). Additionally, when there is one type of grating pitch, N also represents the repeating cycle of inter-electrode voltages with one pattern electrode 32a as a unit (hereinafter simply referred to as “repeating cycle of inter-electrode voltages”).

Meanwhile, another known liquid crystal mode other than the vertical electric field mode is a mode that causes the refractive index of a liquid crystal layer to change by generating an electric field in a direction parallel to a pair of glass substrates (hereinafter referred to as “horizontal electric field”) between adjacent pattern electrodes. A liquid crystal mode that generates a horizontal electric field is commonly referred to as a “horizontal electric field mode.” An example of a horizontal electric field mode is IPS (In-Plane Switching). It is known that, conventionally, the response speed of liquid crystals depends on the cell gap in a vertical electric field mode, and the response speed of liquid crystals depends on the electrode pitch in a horizontal electric field mode. Since electrode pitch can be sufficiently reduced in a horizontal electric field mode, it is possible to increase the response speed of liquid crystals in this electric field mode more than in a vertical electric field mode.

FIG. 20 is a cross-sectional view showing a configuration of a conventional liquid crystal diffraction element 40 that is driven by a horizontal electric field mode. The liquid crystal diffraction element 40 is equipped with: a pair of glass substrates 41a and 41b; a liquid crystal layer 45 sandwiched between the pair of glass substrates 41a and 41b; an interlayer insulation film 42 provided on a surface of the glass substrate 41a on the side of the liquid crystal layer 45; and a plurality of pattern electrodes 43 arranged in a stripe pattern over a surface of the glass substrate 41a on the side of the liquid crystal layer 45 with the interlayer insulation film 42 therebetween. An alignment film 44 is provided on the plurality of pattern electrodes 43. In contrast to the liquid crystal diffraction element 30 that is driven by a vertical electric field mode, the liquid crystal diffraction element 40, which is driven by a horizontal electric field mode, is not equipped with the common electrode 32b. The liquid crystal diffraction element 40 controls the diffraction angle of incident light by generating a horizontal electric field, an electric field parallel to the pair of glass substrates 31a and 31b, between the adjacent pattern electrodes 43, and causing the refractive index of the liquid crystal layer 45 to change. More particularly, the liquid crystal diffraction element 40 forms a diffraction grating by applying a prescribed voltage to each of the pattern electrodes 43 and generating a region with a spatial refractive index modulation in the liquid crystal layer 45. The liquid crystal diffraction element 40, which is driven by a horizontal electric field mode, is described in Patent Document 2, for example.

FIG. 21 is a diagram for describing conventional electrode-applied voltages (refers to the voltages applied to the pattern electrodes 43) for forming a blazed-type diffraction grating in the liquid crystal diffraction element 40 shown in FIG. 20. In FIG. 21, |VLC| represents the absolute values of inter-electrode voltages, and Vpixel represents electrode-applied voltages. Note that, in the descriptive portion of this specification, the absolute values of inter-electrode voltages are represented by VLC, and not by |VLC|. The inter-electrode voltages VLC of 0V, 1V, 2V, 3V, 0V, 1V, 2V, and 3V are generated in that order from the left side of FIG. 21, and an amount of phase modulation (refractive index) corresponding to the respective inter-electrode voltage is obtained. More particularly, the inter-electrode voltages VLC of 0V, 1V, 2V, 3V, 0V, 1V, 2V, and 3V are respectively generated between: the first and second pattern electrodes 43a; the second and third pattern electrodes 43a; the third and fourth pattern electrodes 43a; the fourth and fifth pattern electrodes 43a; the fifth and sixth pattern electrodes 43a; the sixth and seventh pattern electrodes 43a; the seventh and eighth pattern electrodes 43a; and the eighth and ninth pattern electrodes 43a. In this manner, a blazed-type diffraction grating with a grating pitch that is four times the electrode pitch (N=4) is formed.

### RELATED ART DOCUMENTS

### Patent Documents

Patent Document 1: Japanese Patent Application Laid-Open Publication No. 2003-233094

Patent Document 2: Japanese Patent Application Laid-Open Publication No. 2009-69297

### SUMMARY OF THE INVENTION

### Problems to be Solved by the Invention

Meanwhile, in the conventional liquid crystal diffraction element 40 that is driven by a horizontal electric field mode, it is necessary to incrementally change the electrode-applied voltage Vpixel to be applied to each pattern electrode 43a in order to form a blazed-type diffraction grating such as the one shown in FIG. 21 (see the description of an embodiment 1 in Patent Document 2). In the example shown in FIG. 21, it is necessary to apply the electrode-applied voltages Vpixel of 0V, 0V, +1V, +3V, +6V, +6V, +7V, +9V, and +12V respectively to the first to ninth pattern electrodes 43a. In this manner, the electrode-applied voltages Vpixel are increased after each repeating cycle of the inter-electrode voltages VLC of 0V, 1V, 2V, and 3V.

Therefore, the present invention aims to provide: a light deflection device that is capable of forming a blazed-type diffraction grating while suppressing an increase in electrode-applied voltage using a horizontal electric field mode; and a method of driving a light deflection element.

### Means for Solving the Problems

A first aspect of the present invention is a light deflection device equipped with a light deflection element and a driving circuit that drives the light deflection element;

wherein the light deflection element includes:

a pair of transparent substrates;

a medium with an anisotropic refractive index sandwiched between the pair of transparent substrates and having a refractive index that changes due to an electro-optic effect; and

a plurality of transparent electrodes for generating an electric field in a direction parallel to the pair of transparent substrates;

wherein the driving circuit applies a positive voltage that is greater than a reference voltage to at least one of the plurality of transparent electrodes while applying a negative voltage that is smaller than the reference voltage to at least one of the plurality of transparent electrodes to which the positive voltage is not applied and causes inter-electrode voltages generated between respective adjacent transparent electrodes to change incrementally and periodically.

A second aspect of the present invention is the first aspect of the present invention, wherein the driving circuit generates voltages to be respectively applied to the plurality of transparent electrodes such that the inter-electrode voltages vary incrementally in the parallel direction in accordance with one type of combination of the inter-electrode voltages.

A third aspect of the present invention is the second aspect of the present invention, wherein the driving circuit repeats the voltages to be respectively applied to the plurality of transparent electrodes in a period that is twice the number of inter-electrode voltages constituting the one type of combination.

A fourth aspect of the present invention is the first aspect of the present invention, wherein the driving circuit generates voltages to be respectively applied to the plurality of transparent electrodes such that the inter-electrode voltages vary incrementally in the parallel direction in accordance with a plurality of types of combinations of the inter-electrode voltages.

A fifth aspect of the present invention is the fourth aspect of the present invention, wherein the driving circuit repeats the voltages to be respectively applied to the plurality of transparent electrodes in the parallel direction in a period that is twice the sum of the inter-electrode voltages constituting the plurality of types of combinations.

A sixth aspect of the present invention is the first aspect of the present invention, wherein the driving circuit applies positive voltage that are identical to each other or negative voltages that are identical to each other to two mutually adjacent transparent electrodes among the plurality of transparent electrodes.

A seventh aspect of the present invention is the first aspect of the present invention, wherein the driving circuit applies the reference voltage to the plurality of transparent electrodes to which neither the positive voltage nor the negative voltage is applied.

An eighth aspect of the present invention is a method of driving a light deflection element equipped with: a pair of transparent substrates, a medium with an anisotropic refractive index sandwiched between the pair of transparent substrates and having a refractive index that changes due to an electro-optic effect; and a plurality of transparent electrodes for generating an electric field in a direction parallel to the pair of transparent substrates, the method including:

applying voltages, including:
applying a positive voltage that is larger than a reference voltage to at least one of the transparent electrodes;
applying a negative voltage that is smaller than the reference voltage to at least one of the transparent electrodes to which the positive voltage is not applied; and
generating inter-electrode voltages between respective adjacent transparent electrodes that vary incrementally and periodically.

A ninth aspect of the present invention is the eighth aspect of the present invention, wherein, in the step of applying voltages, voltages to be respectively applied to the plurality of transparent electrodes are generated so as to cause the inter-electrode voltages to vary incrementally in the parallel direction in accordance with one type of combination of the inter-electrode voltages.

A tenth aspect of the present invention is the ninth aspect of the present invention, wherein, in the step of applying voltages, the voltages to be respectively applied to the plurality of transparent electrodes are repeated in the parallel direction in a period that is twice the number of inter-electrode voltages constituting the one type of combination.

An eleventh aspect of the present invention is the eighth aspect of the present invention, wherein, in the step of applying voltages, voltages to be respectively applied to the plurality of transparent electrodes are generated so as to cause the inter-electrode voltages to vary incrementally in the parallel direction in accordance with a plurality of types of combinations of the inter-electrode voltages.

A twelfth aspect of the present invention is the eleventh aspect of the present invention, wherein, in the step of applying voltages, the voltages to be respectively applied to the plurality of transparent electrodes are repeated in the parallel direction in a period that is twice the sum of the inter-electrode voltages respectively constituting the plurality of types of combinations.

A thirteenth aspect of the present invention is the eighth aspect of the present invention, wherein, in the step of applying voltages, positive voltages that are identical to each other or negative voltages that are identical to each other are applied to two mutually adjacent transparent electrodes among the plurality of transparent electrodes.

A fourteenth aspect of the present invention is the eighth aspect of the present invention, wherein, in the step of applying voltages, the reference voltage is applied to the plurality of transparent electrodes to which neither the positive voltage nor the negative voltage is applied.

### Effects of the Invention

According to the first aspect of the present invention, by using a mixture of positive voltages and negative voltages as electrode-applied voltages, which are voltages to be applied to a plurality of transparent electrodes (corresponding to the pattern electrodes described above), and generating a horizontal electric field by using a plurality of transparent electrodes, the refractive index of a medium with an anisotropic refractive index changes incrementally and cyclically in a direction parallel to transparent substrates, and a blazed-type diffraction grating is formed. In this manner, by using a mixture of positive voltages and negative voltages as electrode-applied voltages, it is possible to suppress an increase in electrode-applied voltage when forming a blazed diffraction grating using a horizontal electric field mode.

According to the second aspect of the present invention, because an inter-electrode voltage changes incrementally based on one type of combination of inter-electrode voltages, it is possible to form a blazed-type diffraction grating having one type of grating pitch.

According to the third aspect or the fifth aspect of the present invention, electrode-applied voltages are repeated in a fixed cycle. This reduces the amount of information indicating an electrode-applied voltage to be transmitted in a signal to a driving circuit that generates an electrode-applied voltage. Since this shortens the transmission time of the signal to be transmitted to the driving circuit, it is possible to increase the speed of driving the light deflection element.

According to the fourth aspect of the present invention, since an inter-electrode voltage changes incrementally based on a plurality of types of combinations of inter-electrode voltages, it is possible to form a blazed-type diffraction grating having a plurality of types of grating pitches.

According to the sixth aspect of the present invention, by applying identical electrode-applied voltages to two adjacent transparent electrodes, it is possible to generate an inter-electrode voltage of 0V.

According to the seventh aspect of the present invention, by including a voltage serving as a reference in electrode-applied voltages, it is possible to achieve the same effect as that of the first aspect of the present invention.

According to the eighth to fourteenth aspects of the present invention, it is possible to achieve the same effects as those of the first to seventh aspects of the present invention, respectively, by using a method of driving a light deflection element.

### BRIEF DESCRIPTION OF THE DRAWINGS

FIG. 1 is a block diagram showing a configuration of a light deflection device pertaining to Embodiment 1 of the present invention.

FIG. 2 is a cross-sectional view showing a configuration of the liquid crystal diffraction element shown in FIG. 1.

FIG. 3 is a plan view for describing a layout of the pattern electrodes shown in FIG. 2.

FIG. 4 is a diagram showing a relationship between electrode pitch and diffraction angle.

FIG. 5 is a cross-sectional view for describing a case where a blazed-type diffraction grating is formed by using conventional electrode-applied voltages in the liquid crystal diffraction element shown in FIG. 2.

FIG. 6 is a diagram showing electrode-applied voltages on respective pattern electrodes and inter-electrode voltages generated by the respective electrode-applied voltages in a case where a blazed-type diffraction grating is formed by using conventional electrode-applied voltages in the liquid crystal diffraction element shown in FIG. 2.

FIG. 7 is a cross-sectional view for describing an example of electrode-applied voltages according to Embodiment 1.

FIG. 8 is a diagram showing an example of electrode-applied voltages on respective pattern electrodes and inter-electrode voltages generated by the respective electrode-applied voltages according to Embodiment 1.

FIG. 9 is a cross-sectional view for describing another example of electrode-applied voltages according to Embodiment 1.

FIG. 10 is a cross-sectional view for describing an example of electrode-applied voltages in a case where the number of inter-electrode voltages is set to three according to Embodiment 2 of the present invention.

FIG. 11 is a diagram showing electrode-applied voltages on respective pattern electrodes and inter-electrode voltages in a case where the number of inter-electrode voltages is set to three according to Embodiment 2.

FIG. 12 is a cross-sectional view for describing an example of electrode-applied voltages in a case where the number of inter-electrode voltages is set to four according to Embodiment 2 of the present invention.

FIG. 13 is a diagram showing electrode-applied voltages to respective pattern electrodes and inter-electrode voltages in a case where the number of inter-electrode voltages is set to four according to Embodiment 2.

FIG. 14 is a cross-sectional view for describing an example of electrode-applied voltages in a case where the numbers of the first and second inter-electrode voltages are respectively set to three and two according to Embodiment 3 of the present invention.

FIG. 15 is a diagram showing electrode-applied voltages on respective transparent electrodes and inter-electrode voltages in a case where the numbers of the first and second inter-electrode voltages are respectively set to three and two according to Embodiment 3.

FIG. 16 is a cross-sectional view for describing an example of electrode-applied voltages on respective transparent electrodes in a case where the numbers of the first and second inter-electrode voltages are respectively set to four and three according to Embodiment 3.

FIG. 17 is a cross-sectional view showing electrode-applied voltages on respective transparent electrodes and inter-electrode voltages in a case where the numbers of the first and second inter-electrode voltages are set to four and three according to Embodiment 3.

FIG. 18 is a cross-sectional view showing a configuration of a conventional liquid crystal diffraction element driven by a vertical electric field mode.

FIG. 19 is a cross-sectional view for describing a relationship between inter-electrode voltage and diffraction grating pattern when a blazed-type diffraction grating is formed in the liquid crystal diffraction element shown in FIG. 18.

FIG. 20 is a cross-sectional view showing a configuration of a conventional liquid crystal diffraction element driven by a horizontal electric field mode.

FIG. 21 is a cross-sectional view for describing conventional electrode-applied voltages in the liquid crystal diffraction element shown in FIG. 20.

FIG. 22 is a plan view for describing a layout of pattern electrodes in a liquid crystal diffraction element described in Patent Document 1.

### DETAILED DESCRIPTION OF EMBODIMENTS

Embodiments 1 to 3 of the present invention will be described below with reference to attached diagrams. While each of the following embodiments will be described with the assumption that a liquid crystal (a liquid crystal layer) is employed as a medium with an anisotropic refractive index, the present invention is not limited by these embodiments. Another medium with an anisotropic refractive index in which a refractive index changes due to an electro-optic effect may be used in lieu of a liquid crystal. Additionally, each of the following embodiments will be described with the assumption that glass substrates are employed as transparent substrates; the present invention is not limited by these embodiments, however.

### 1. Embodiment 1

### 1.1 Light Deflection Device

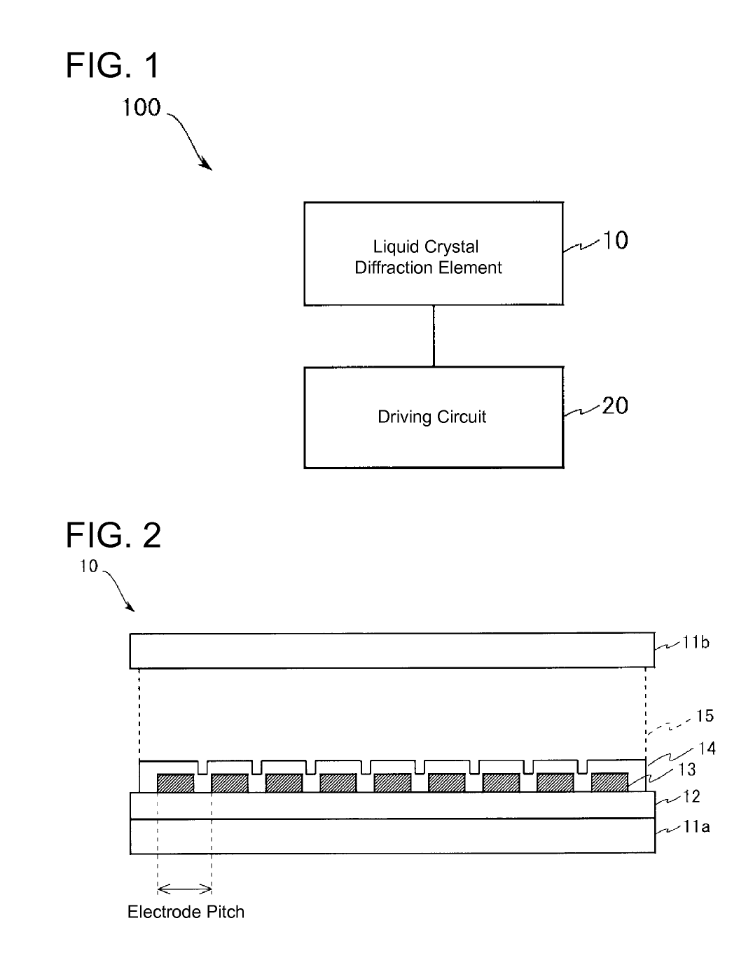

FIG. 1 is a block diagram showing a configuration of a light deflection device 100 pertaining to Embodiment 1 of the present invention. The light deflection device 100 is equipped with a liquid crystal diffraction element 10, which is a light deflection element using liquid crystal, and a driving circuit 20. The liquid crystal diffraction element 10 forms a diffraction grating. The driving circuit 20 applies electrode-applied voltages Vpixel to pattern electrodes 13, which are provided in the liquid crystal diffraction element 10 and will be described later. Note that the driving circuit 20 receives a signal indicating the electrode-applied voltage Vpixel (hereinafter referred to as “control signal”) from an external control circuit that is not shown in the diagram, and generates the electrode-applied voltage Vpixel based on the respective control signal.

### 1.2 Liquid Crystal Diffraction Element

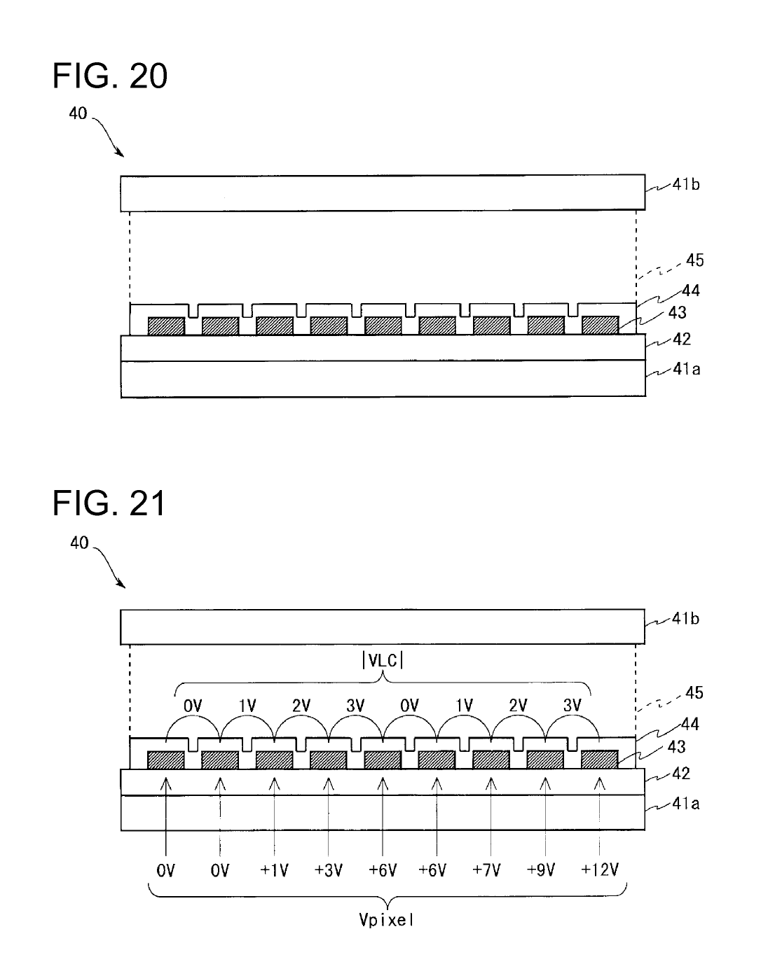

FIG. 2 is a cross-sectional view of a configuration of the liquid crystal diffraction element 10 shown in FIG. 1. The liquid crystal diffraction element 10 is driven by a horizontal electric field mode, and is basically configured in the same manner as the conventional liquid crystal diffraction element 40 shown in FIG. 20, except for the layout of the pattern electrodes 13, which will be described later. The liquid crystal diffraction element 10 is equipped with: a pair of glass substrates 11a and 11b; a liquid crystal layer 15 sandwiched between the pair of glass substrates 11a and 11b; an interlayer insulation film 12 provided on a surface of the glass substrate 11b on the side of the liquid crystal layer 15; and a plurality of pattern electrodes 13 arranged over a surface of the glass substrate 11a on the side of the liquid crystal layer 15 with the interlayer insulation film 12 therebetween. An alignment film 14 is provided on the plurality of pattern electrodes 13. While only nine of the pattern electrodes 13 are illustrated in FIG. 2 for convenience, the number of the pattern electrodes 13 is acceptable, according to the present embodiment, provided that the number is greater than the number of inter-electrode voltages by one or more. Note that the liquid crystal diffraction element 10 is not equipped with a common electrode (a transparent electrode on the side of the glass substrate 11b) since the liquid crystal diffraction element 10 is driven by a horizontal electric field mode. For the liquid crystal layer 15, a nematic liquid crystal or a ferroelectric liquid crystal with a homogeneous molecular alignment is used, for example. An example of a horizontal electric field mode is IPS. The pattern electrodes 13 are formed by metal oxides. Examples of metal oxides include ITO (Indium Tin Oxide) and IZO (Indium Zinc Oxide).

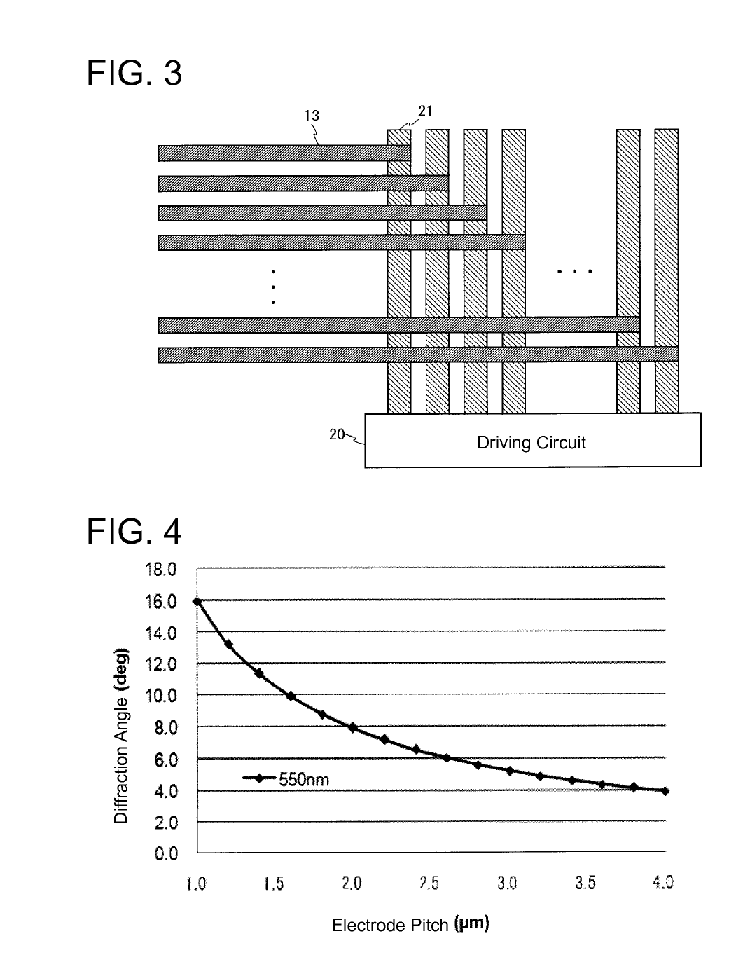

FIG. 3 is a plan view for describing a layout of the pattern electrodes 13 shown in FIG. 2. A plurality of pattern electrodes 13 are arranged over a surface of the glass substrate 1 la on the side of the liquid crystal layer 15 in a stripe pattern with the interlayer insulation film 12 therebetween, and are respectively connected to a plurality of wiring electrodes 21 that are connected to the driving circuit 20. The driving circuit 20 applies the electrode-applied voltages Vpixel respectively to the plurality of pattern electrodes 13 via the plurality of wiring electrodes 21. The action in which the driving circuit 20 applies the electrode-applied voltages Vpixel respectively to the plurality of pattern electrodes 13 corresponds to the step of applying voltages.

Hereinafter, a direction that is parallel to the pair of glass substrates 11a and 11b will be referred to as “substrate-parallel direction,” and a substrate-parallel direction that is also orthogonal to the extending direction of the plurality of pattern electrodes 13 will be referred to as “electrode-orthogonal direction.” The plurality of pattern electrodes 13 are lined up in a substrate-parallel direction and, more particularly, in an electrode-orthogonal direction.

The liquid crystal diffraction element 10 forms a diffraction grating by generating a region with a spatial refractive index modulation corresponding to the electrode-applied voltage Vpixel applied to each pattern electrode 13 in the liquid crystal layer 15. In the present embodiment and in each of the embodiments to be described later, the liquid crystal diffraction element 10 forms a blazed-type diffraction grating. More particularly, by controlling the electrode-applied voltage Vpixel on each pattern electrode 13 independently using the driving circuit 20 and thereby setting a grating pitch (N times the electrode pitch), it is possible to obtain a desired diffraction angle (also referred to as a deflection angle) θ, as shown in the following equation (1):

θ=sin⁻¹(λ/p−sin φ) (1)

Where λ represents the wavelength of incident light, p represents the grating pitch, and φ represents the incident angle of incident light. Below, φ=0 for convenience, and the diffraction angle θ is assumed to be given by the following equation (2).

θ=sin⁻¹(λ/p) (2)

It is clear from equation (2) that the smaller the grating pitch p, the greater the diffraction angle θ.

FIG. 4 is a diagram showing a relationship between electrode pitch and diffraction angle. Here, the grating pitch is set to twice the electrode pitch (N=2). As shown in FIG. 4, in order to set the diffraction angle to 15° or greater, it is necessary to set the electrode pitch to approximately 1.0 μm if N=2, and smaller than approximately 1.0 μm if N=3 or greater.

### 1.3 Conventional Electrode-Applied Voltages

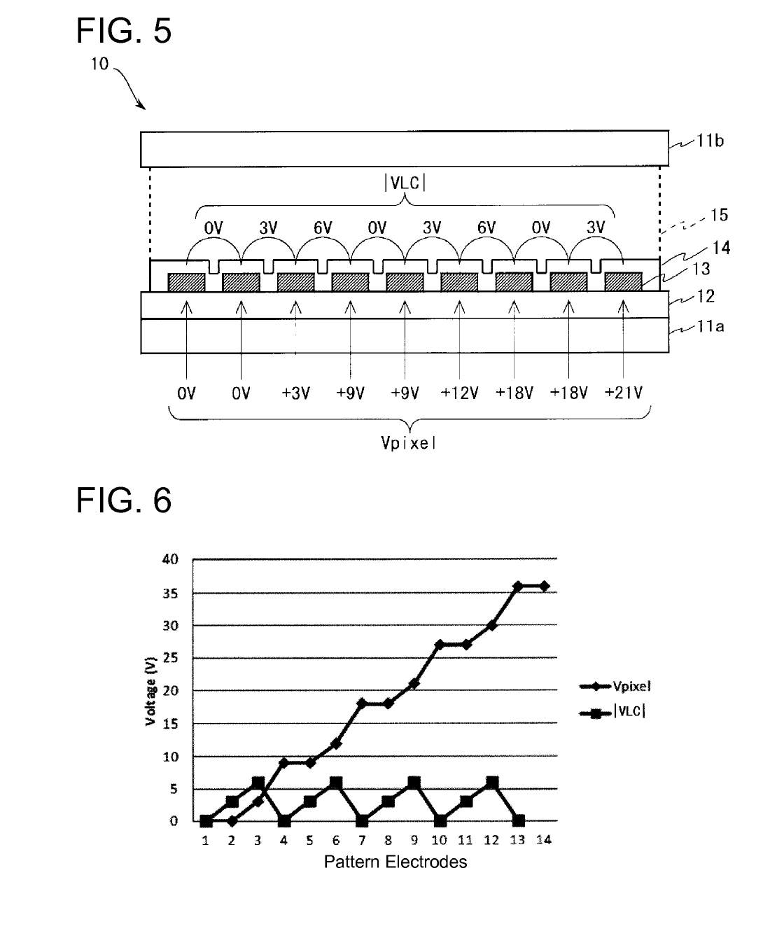

FIG. 5 is a cross-sectional view for describing a case where a blazed-type diffraction grating is formed in the liquid crystal diffraction element 10 shown in FIG. 2 by using conventional electrode-applied voltages Vpixel. FIG. 6 shows the electrode-applied voltages Vpixel on the respective pattern electrodes 13 and inter-electrode voltages VLC generated by the respective electrode-applied voltages Vpixel when a blazed-type diffraction grating is formed in the liquid crystal diffraction element 10 shown in FIG. 2 using the conventional electrode-applied voltages Vpixel. More particularly, FIG. 6 is a diagram showing a value of the electrode-applied voltage Vpixel applied to an X^{th} pattern electrode (here, X=1 to 14) and a value of the inter-electrode voltage VLC generated between the X^{th} pattern electrode 13 and an X+1 pattern electrode 13. Here, FIG. 5 shows only the first to ninth pattern electrodes 13 for convenience.

As shown in FIGS. 5 and 6, the number of inter-electrode voltages and the repeating cycle of the inter-electrode voltages VLC are three. More particularly, when the inter-electrode voltages VLC of 0V, 3V, and 6V are repeated for each three pattern electrodes 13, a blazed-type diffraction grating with a grating pitch that is three times the electrode pitch (N=3) is formed. With respect to the first to ninth pattern electrodes 13 shown in FIG. 5, the inter-electrode voltages VLC of 0V, 3V, 6V, 0V, 3V, 6V, 0V, and 3V are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. With respect to the tenth to fourteenth pattern electrodes 13 that are not illustrated in FIG. 5, the inter-electrode voltages VLC of 6V, 0V, 3V, 6V, and 0V are respectively generated between: the ninth and tenth pattern electrodes 13; the tenth and eleventh pattern electrodes 13; the eleventh and twelfth pattern electrodes 13; the twelfth and thirteenth pattern electrodes 13; and the thirteenth and fourteenth pattern electrodes 13.

Meanwhile, conventionally, only a voltage of 0V, which is a voltage serving as a reference for each of the electrode-applied voltages Vpixel (hereinafter referred to as “reference voltage”), and a positive voltage, which is greater than the reference voltage, are used as electrode-applied voltages Vpixel. This results in an increase in the inter-electrode voltages VLC after each repeating cycle of the inter-electrode voltages VLC. The electrode-applied voltages Vpixel of 0V, 0V, +3V, +9V, +9V, +12V, +18V, +18V, and +21V are respectively applied to the first to ninth pattern electrodes 13 shown in FIG. 5. Meanwhile, the electrode-applied voltages Vpixel of +27V, +27V, +30V, +36V, and +36V are respectively applied to the tenth to fourteenth pattern electrodes 13 not illustrated in FIG. 5 (see FIG. 6).

### 1.4 Electrode-Applied Voltages according to the Present Embodiment

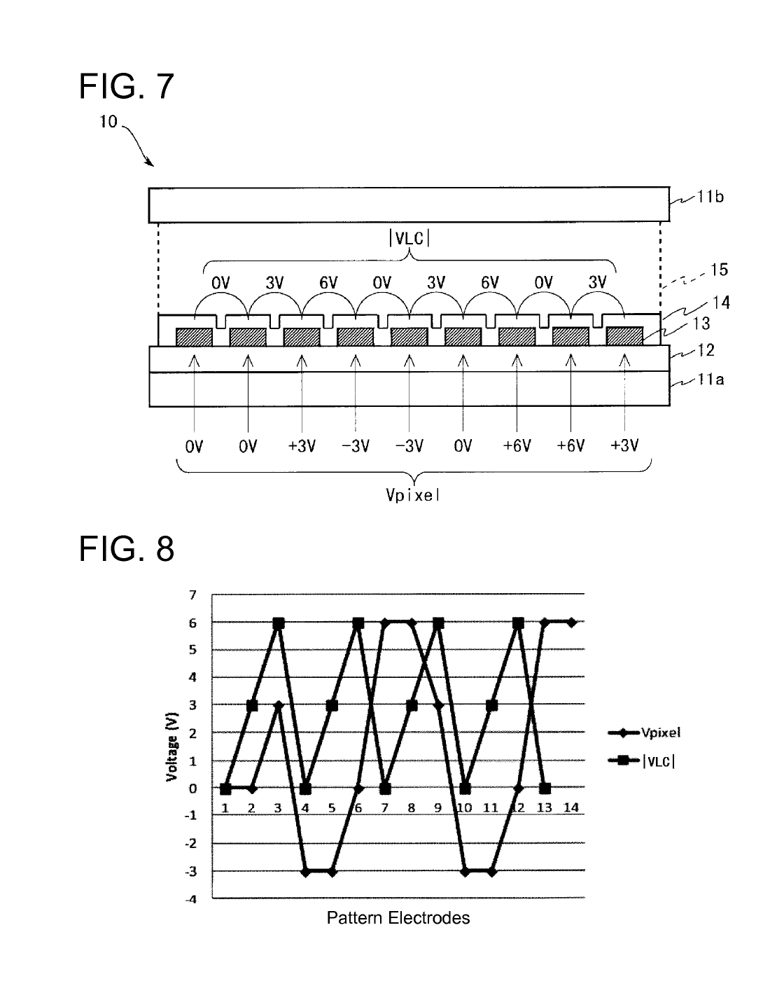

FIG. 7 is a cross-sectional view for describing an example of the electrode-applied voltages Vpixel according to the present embodiment. FIG. 8 is a diagram that shows an example of the electrode-applied voltages Vpixel on the respective pattern electrodes 13 according to the present embodiment and the inter-electrode voltages VLC generated by the respective electrode-applied voltages Vpixel. In the present embodiment, in addition to the reference voltage and the positive voltage described above, a negative voltage that is smaller than the reference voltage is used as the electrode-applied voltage Vpixel. In other words, the positive voltage is applied to any one or more of the pattern electrodes 13 of the plurality of pattern electrodes 13, and the negative voltage is applied to any one or more of the pattern electrodes 13 of the plurality of pattern electrodes 13 to which the positive voltage is not applied, and the reference voltage is applied to the pattern electrodes 13 to which neither the positive voltage nor the negative voltage is applied.

The electrode-applied voltages Vpixel of 0V, 0V, +3V, 3V, 3V, 3V, 0V, +6V, +6V, and +3V are respectively applied to the first to ninth pattern electrodes 13 shown in FIG. 7. Meanwhile, the electrode-applied voltages Vpixel of −3V, −3V, 0V, +6V, and +6V are respectively applied to the tenth to fourteenth pattern electrodes 13 not illustrated in FIG. 7 (see FIG. 8). Of the first to fourteenth pattern electrodes 13: the reference voltages of 0V that are identical to each other are applied to the first and second pattern electrodes 13 that are adjacent to each other; the negative voltages of −3V that are identical to each other are applied to the fourth and fifth pattern electrodes 13 that are adjacent to each other; the positive voltages of +6V that are identical to each other are applied to the seventh and eighth pattern electrodes 13 that are adjacent to each other; the negative voltages of −3V that are identical to each other are applied to the tenth and eleventh pattern electrodes 13 that are adjacent to each other; and the positive voltages of +6V that are identical to each other are applied to the thirteenth and fourteenth pattern electrodes 13 that are adjacent to each other. As a result, the inter-electrode voltages VLC of 0V are generated.

With respect to the first to ninth pattern electrodes 13 shown in FIG. 7, the inter-electrode voltages VLC of 0V, 3V, 6V, 0V, 3V, 6V, 0V, and 3V are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. With respect to the tenth to fourteenth pattern electrodes 13 not illustrated in FIG. 7, the inter-electrode voltages VLC of 6V, 0V, 3V, 6V, and 0V are respectively generated between: the ninth and tenth pattern electrodes 13; the tenth and eleventh pattern electrodes 13; the eleventh and twelfth pattern electrodes 13; the twelfth and thirteenth pattern electrodes 13; and the thirteenth and fourteenth pattern electrodes 13. Therefore, in the same manner as the example shown in FIGS. 5 and 6, the number of inter-electrode voltages and the repeating cycle of the inter-electrode voltages VLC become three. In other words, the inter-electrode voltages VLC of 0V, 3V, and 6V are repeated for each three pattern electrodes 13, and a blazed-type diffraction grating with a grating pitch that is three times the electrode pitch (N=3) is formed as a result.

Thus, in the example shown in FIGS. 7 and 8, the electrode-applied voltages Vpixel are set by the driving circuit 20 such as to cause the inter-electrode voltage VLC to change incrementally in the order of 0V, 3V, and 6V in an electrode-orthogonal direction based on a combination constituted by the inter-electrode voltages VLC of 0V, 3V, and 6V, or, in other words, on one type of combination of the inter-electrode voltages VLC.

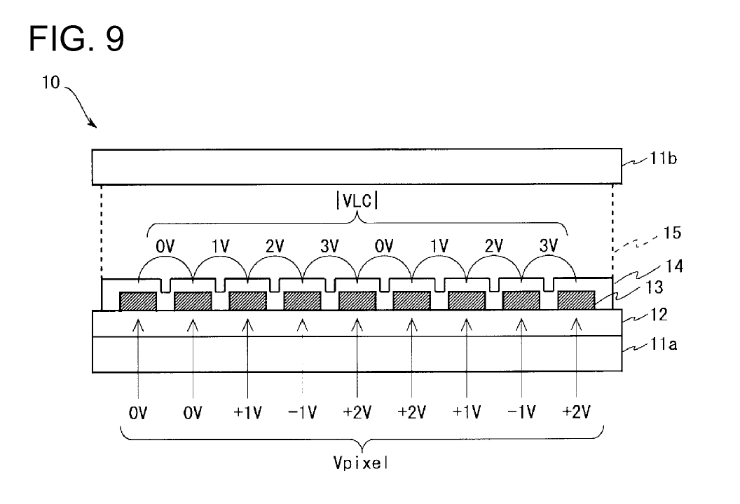

FIG. 9 is a cross-sectional view for describing another example of the electrode-applied voltages Vpixel according to the present embodiment. The electrode-applied voltages Vpixel of 0V, 0V, +1V, −1V, +2V, +2V, +1V, −1V, and +2V are respectively applied to the first to ninth pattern electrodes 13 shown in FIG. 9. Of the first to ninth pattern electrodes 13, the reference voltages of 0V that are identical to each other are applied to the first and second pattern electrodes 13 that are adjacent to each other, and the positive voltages of +2V that are identical to each other are applied to the fifth and sixth pattern electrodes 13 that are adjacent to each other. As a result, the inter-electrode voltages VLC of 0V are generated in the same manner as the example shown in FIGS. 7 and 8.

The inter-electrode voltages VLC of 0V, 1V, 2V, 3V, 0V, 1V, 2V, and 3V are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. Therefore, the number of inter-electrode voltages and the repeating cycle of the inter-electrode voltages VLC are four. In other words, the inter-electrode voltages VLC of 0V, 1V, 2V, and 3V are repeated for every four pattern electrodes 13, and a blazed-type diffraction grating with a grating pitch that is four times the electrode pitch (N=4) is formed as a result.

Thus, in the example shown in FIG. 9, the electrode-applied voltages Vpixel are set by the driving circuit 20 such as to cause the inter-electrode voltage VLC to change incrementally in the order of 0V, 1V, 2V, and 3V in an electrode-orthogonal direction based on a combination constituted by the inter-electrode voltages VLC of 0V, 1V, 2V, and 3V, or, in other words, on one type of combination of the inter-electrode voltages VLC.

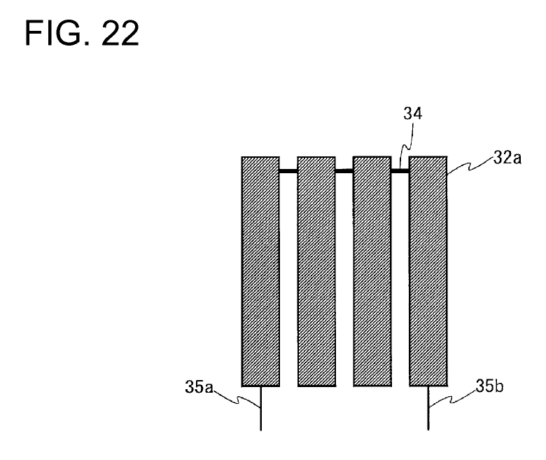

Meanwhile, in the liquid crystal diffraction element 30 described in Patent Document 1, adjacent pattern electrodes 32a are connected to one another via high resistance wiring lines 34. By applying a low voltage and a high voltage respectively to two of the pattern electrodes 32a placed on both ends through lead-out electrode lines 35a and 35b, an electrode-applied voltage Vpixel to be applied to each pattern electrode 32a is changed incrementally (see FIG. 22). For this reason, if a horizontal electric field mode is employed in the liquid crystal diffraction element 30 that was described in Patent Document 1, for example, it is not possible to use both a positive voltage and a negative voltage as electrode-applied voltages Vpixel at the same time, unlike in the case of the present embodiment.

### 1.5 Effects

According to the present embodiment, by using a mixture of positive voltages and negative voltages as the electrode-applied voltages Vpixel and generating a horizontal electric field with the plurality of pattern electrodes 13, the refractive index of the liquid crystal layer 15 changes incrementally as well as cyclically in a substrate-parallel direction (more particularly, in an electrode-orthogonal direction) and a blazed-type diffraction grating is formed. In this manner, by using a mixture of positive voltages and negative voltages for the electrode-applied voltages Vpixel, it is possible to suppress an increase in the electrode-applied voltages Vpixel when a blazed-type diffraction grating is formed using a horizontal electric field mode.

Additionally, according to the present invention, since the electrode-applied voltage VLC changes incrementally based on one type of combination of the electrode-applied voltages VLC, it is possible to form a blazed-type diffraction grating with one type of grating pitch.

### 2. Embodiment 2

### 2.1 Electrode-Applied Voltages

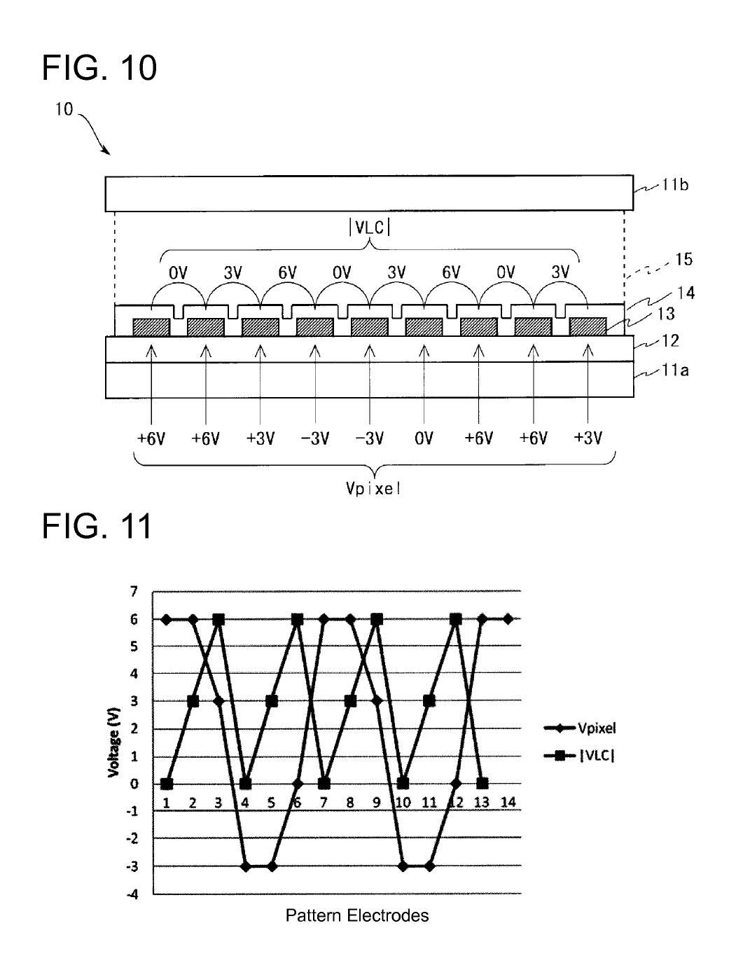

FIG. 10 is a cross-sectional view for describing an example of electrode-applied voltages Vpixel when the number of inter-electrode voltages is set to three according to Embodiment 2 of the present invention. FIG. 11 is a diagram showing the electrode-applied voltages Vpixel on respective pattern electrodes 13 and inter-electrode voltages VLC when the number of inter-electrode voltages for the inter-electrode voltages VLC is set to three according to the present embodiment. The component elements of the present embodiment that are identical to the elements of Embodiment 1 are marked with identical reference characters, and are omitted from the description accordingly. In the example shown in FIGS. 10 and 11, while the inter-electrode voltages VLC are identical to those of the example shown in FIGS. 5 and 6, the electrode-applied voltages Vpixel are different from those of the example shown in FIGS. 5 and 6. Specifically, the electrode-applied voltages Vpixel of +6V, +6V, +3V, −3V, −3V, 0V, +6V, +6V, and +3V are respectively applied to the first to ninth pattern electrodes 13 shown in FIG. 10. Meanwhile, the electrode-applied voltages Vpixel of −3V, −3V, 0V, +6V, and +6V are respectively applied to the tenth to fourteenth pattern electrodes 13 not illustrated in FIG. 10.

With respect to the first to ninth pattern electrodes 13 shown in FIG. 10, the inter-electrode voltages VLC of 0V, 3V, 6V, 0V, 3V, 6V, 0V, and 3V are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. With respect to the tenth to fourteenth pattern electrodes 13 that are not illustrated in FIG. 10, the inter-electrode voltages VLC of 6V, 0V, 3V, 6V, and 0V are respectively generated between: the ninth and tenth pattern electrodes 13; the tenth and eleventh pattern electrodes 13; the eleventh and twelfth pattern electrodes 13; the twelfth and thirteenth pattern electrodes 13; and the thirteenth and fourteenth pattern electrodes 13. Therefore, the number of inter-electrode voltages and the repeating cycle of the inter-electrode voltages VLC are three. In other words, the inter-electrode voltages VLC of 0V, 3V, and 6V are repeated for every three pattern electrodes 13, and a blazed-type diffraction grating having a grating pitch that is three times the electrode pitch (N=3) is formed as a result.

Thus, in the example shown in FIGS. 10 and 11, the electrode-applied voltages Vpixel are generated by a driving circuit 20 such that the electrode-applied voltages Vpixel are repeated in a cycle that is twice the number of inter-electrode voltages (repeating cycle of the inter-electrode voltages VLC) in a substrate-parallel direction (more particularly, in an electrode-orthogonal direction). Specifically, since the repeating cycle in the example shown in FIGS. 10 and 11 is three, the electrode-applied voltages Vpixel of +6V, +6V, +3V, −3V, −3V, and 0V are repeated for every six pattern electrodes 13.

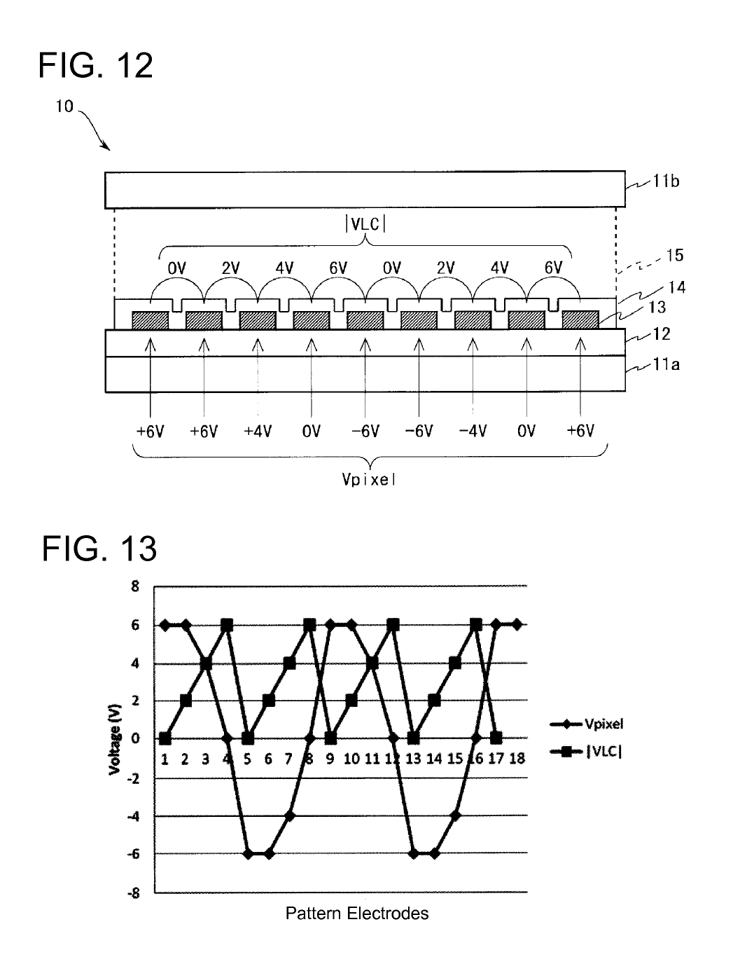

FIG. 12 is a cross-sectional view for describing an example of the electrode-applied voltages Vpixel when the number of inter-electrode voltages is set to four according to the present embodiment. FIG. 13 is a diagram showing the electrode-applied voltages Vpixel on the respective pattern electrodes 13 and the inter-electrode voltages VLC when the number of inter-electrode voltages is set to four according to the present embodiment. While the number of the pattern electrodes 13 is set to fourteen in Embodiment 1, the example shown in FIGS. 12 and 13 will be described with the assumption that the number of the pattern electrodes 13 is eighteen. The electrode-applied voltages Vpixel of +6V, +6V, +4V, 0V, −6V, −6V, −4V, 0V, and +6V are respectively applied to the first to ninth pattern electrodes 13 shown in FIG. 12. Meanwhile, the electrode-applied voltages Vpixel of +6V, +4V, 0V, −6V, −6V, −4V, 0V, +6V, and +6V are respectively applied to the tenth to eighteenth pattern electrodes 13 not illustrated in FIG. 12.

With respect to the first to ninth pattern electrodes 13 shown in FIG. 12, the inter-electrode voltages VLC of 0V, 2V, 4V, 6V, 0V, 2V, 4V, and 6V are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. With respect to the tenth to eighteenth pattern electrodes 13 that are not illustrated in FIG. 12, the inter-electrode voltages VLC of 0V, 2V, 4V, 6V, 0V 2V, 4V, 6V, and 0V are respectively generated between: the ninth and tenth pattern electrodes 13; the tenth and eleventh pattern electrodes 13; the eleventh and twelfth pattern electrodes 13; the twelfth and thirteenth pattern electrodes 13; the thirteenth and fourteenth pattern electrodes 13; the fourteenth and fifteenth pattern electrodes 13; the fifteenth and sixteenth pattern electrodes 13; the sixteenth and seventeenth pattern electrodes 13; and the seventeenth and eighteenth electrodes 13. Therefore, the number of inter-electrode voltages and the repeating cycle of the inter-electrode voltages VLC are four. In other words, the inter-electrode voltages VLC of 0V, 2V, 4V, and 6V are repeated for every four pattern electrodes 13, and a blazed-type diffraction grating with a grating pitch that is four times the electrode pitch (N=4) is formed as a result.

Thus, in the example shown in FIGS. 12 and 13, the electrode-applied voltages Vpixel are generated by a driving circuit 20 such that the electrode-applied voltages Vpixel are repeated in a cycle that is twice the number of inter-electrode voltages (repeating cycle of the inter-electrode voltages VLC) in a substrate-parallel direction (more particularly, in an electrode-orthogonal direction). Specifically, since the repeating cycle in the example shown in FIGS. 12 and 13 is four, the electrode-applied voltages Vpixel of +6V, +6V, +4V, 0V, −6V, −6V, −4V, and 0V are repeated for every eight pattern electrodes 13.

### 2.2 Effects

According to the present embodiment, the electrode-applied voltages Vpixel are repeated in a fixed cycle, or, more particularly, in a cycle that is twice the number of inter-electrode voltages (repeating cycle). This reduces the amount of information indicating the electrode-applied voltages Vpixel to be transmitted in a control signal to the driving circuit 20, which generates the electrode-applied voltages Vpixel. Since this shortens the transmission time of the control signal, it is possible to increase the speed of driving the liquid crystal diffraction element 10.

### 3. Embodiment 3

### 3.1 Electrode-Applied Voltages

While the blazed-type diffraction grating in the first and second embodiments has one type of grating pitch, a blazed-type diffraction grating according to Embodiment 3 of the present invention has two types of grating pitches. Hereinafter, the two types of grating pitches will be respectively referred to as first and second grating pitches. The numbers of inter-electrode voltages for realizing the first and second grating pitches are different from each other. Hereinafter, the numbers of inter-electrode voltages for realizing the first and second grating pitches will be respectively referred to as “numbers of the first and second inter-electrode voltages.” The first and second grating pitches are repeated in an electrode-orthogonal direction, for example. In this case, the repeating cycle of inter-electrode voltages VLC is the sum of the numbers of the first and second inter-electrode voltages.

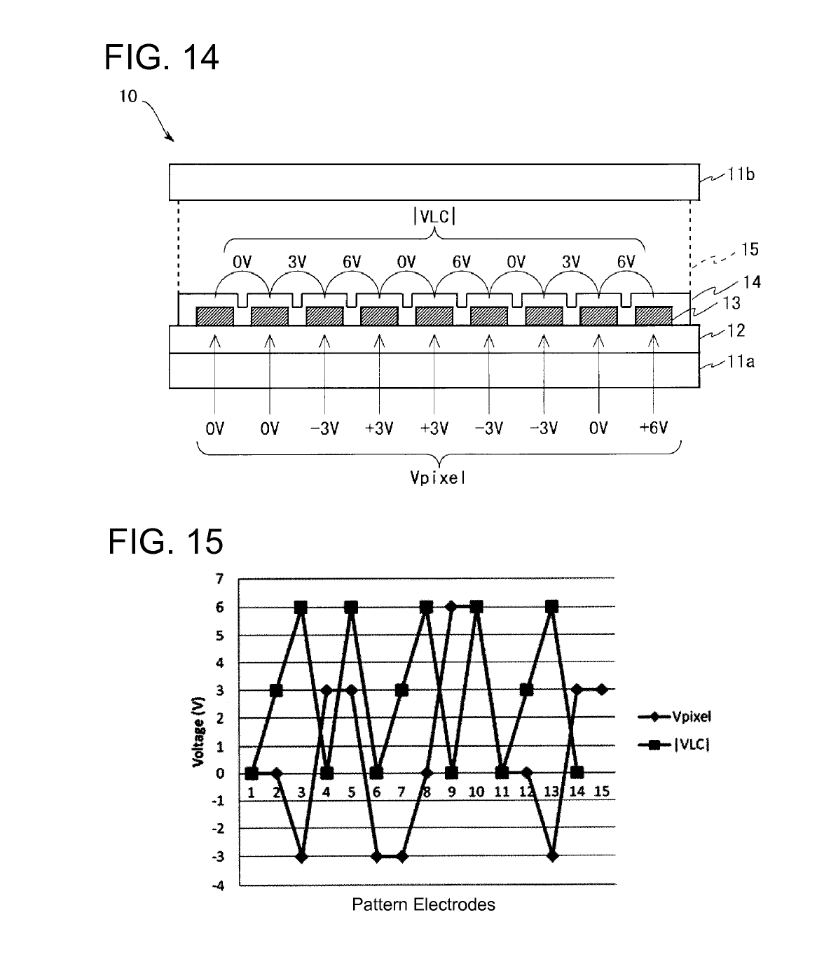

FIG. 14 is a cross-sectional view for describing an example of electrode-applied voltages Vpixel when the numbers of the first and second inter-electrode voltages are respectively set to three and two according to the present embodiment. FIG. 15 is a diagram showing the electrode-applied voltages Vpixel on respective pattern electrodes 13 and the inter-electrode voltages VLC when the numbers of the first and second inter-electrode voltages are respectively set to three and two according to the present embodiment. The component elements of the present embodiment that are identical to the elements of Embodiment 1 are marked with identical reference characters, and are omitted from the description accordingly. In the example shown in FIGS. 14 and 15, the number of the pattern electrodes 13 is assumed to be twenty or more. Further, description will focus on the first to twentieth pattern electrodes 13 of these pattern electrodes 13. However, the sixteenth to twentieth pattern electrodes 13 are not illustrated in either FIG. 14 or 15 for convenience.

The electrode-applied voltages Vpixel of 0V, 0V, −3V, +3V, +3V, −3V, −3V, 0V, and +6V are respectively applied to the first to ninth pattern electrodes 13 shown in FIG. 14. The electrode-applied voltages Vpixel of +6V, 0V, 0V, −3V, +3V, +3V, −3V, −3V, 0V, +6V, and +6V are respectively applied to the tenth to twentieth pattern electrodes 13 not illustrated in FIG. 14.

With respect to the first to ninth pattern electrodes 13 shown in FIG. 14, the inter-electrode voltages VLC of 0V, 3V, 6V, 0V, 6V, 0V, 3V, and 6V are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. With respect to the tenth to twentieth pattern electrodes 13 that are not illustrated in FIG. 14, the inter-electrode voltages VLC of 0V, 6V, 0V, 3V, 6V, 0V, 6V, 0V, 3V, 6V, and 0V are respectively generated between: the ninth and tenth pattern electrodes 13; the tenth and eleventh pattern electrodes 13; the eleventh and twelfth pattern electrodes 13; the twelfth and thirteenth pattern electrodes 13; the thirteenth and fourteenth pattern electrodes 13; the fourteenth and fifteenth pattern electrodes 13; the fifteenth and sixteenth pattern electrodes 13; the sixteenth and seventeenth pattern electrodes 13; the seventeenth and eighteenth electrodes 13; the eighteenth and nineteenth pattern electrodes 13; and the nineteenth and twentieth pattern electrodes 13. As a result, a first grating pitch is realized by a combination of the inter-electrode voltages VLC of 0V, 3V, and 6V, and a second grating pitch is realized by a combination of the inter-electrode voltages VLC of 0V and 6V. Since the numbers of the first and second inter-electrode voltages are three and two, respectively, the repeating cycle of the inter-electrode voltages VLC is five. Therefore, a blazed-type diffraction grating with a first grating pitch that is three times the electrode pitch (N=3) and a second grating pitch that is twice the electrode pitch (N=2) is formed by repeating the inter-electrode voltages VLC of 0V, 3V, 6V, 0V, and 6V for every five pattern electrodes 13.

Thus, in the example shown in FIGS. 14 and 15, the electrode-applied voltages Vpixel are generated by a driving circuit 20 such that the electrode-applied voltages Vpixel are repeated in a cycle that is twice the sum of the numbers of the first and second inter-electrode voltages (repeating cycle of the inter-electrode voltages VLC) in a substrate-parallel direction (more particularly, in an electrode-orthogonal direction). Specifically, since the repeating cycle is five, the electrode-applied voltages Vpixel of 0V, 0V, −3V, +3V, +3, −3V, −3V, 0V, +6V, and +6V are repeated for every ten pattern electrodes 13.

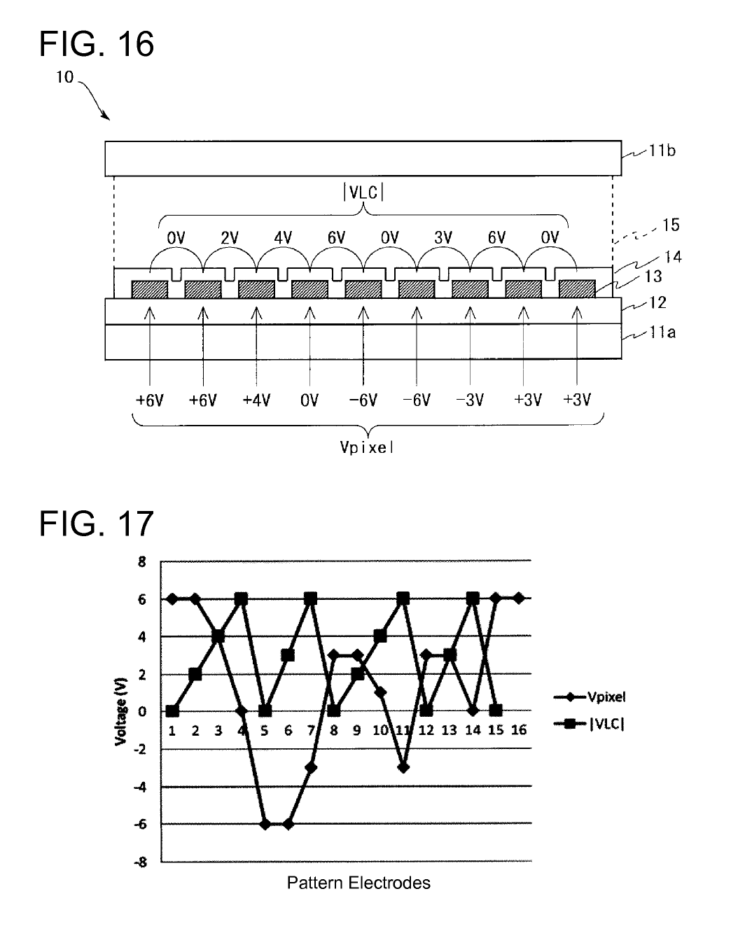

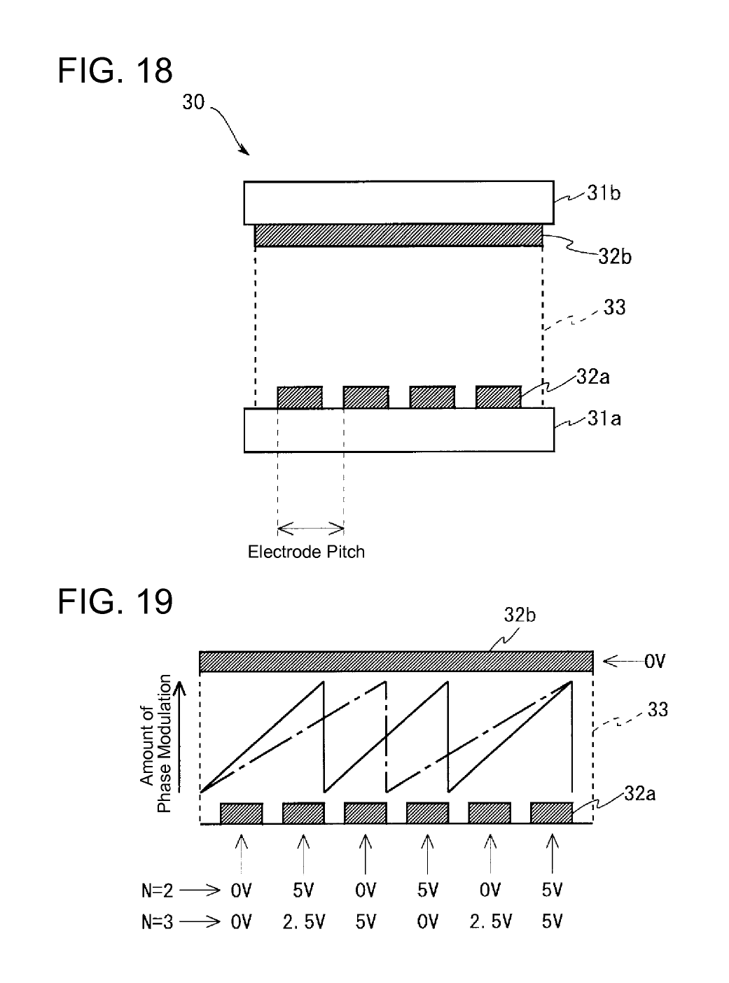

FIG. 16 is a cross-sectional view for describing an example of the electrode-applied voltages Vpixel when the numbers of the first and second inter-electrode voltages are respectively set to four and three according to the present embodiment. FIG. 17 is a diagram showing the electrode-applied voltages Vpixel on the respective pattern electrodes 13 and the inter-electrode voltages VLC when the numbers of the first and second inter-electrode voltages are respectively set to four and three according to the present embodiment. In the example shown in FIGS. 16 and 17, the number of the pattern electrodes 13 is assumed to be at least 28. Further, description will focus on the first to twenty-eighth pattern electrodes 13 of those pattern electrodes 13. However, the seventeenth to twenty-eighth pattern electrodes 13 are not illustrated in either FIG. 16 or FIG. 17 for convenience.

The electrode-applied voltages Vpixel of +6V, +6V, +4V, 0V, −6V, −6V, −3V, +3V, and +3V, are respectively applied to the first to ninth pattern electrodes 13 shown in FIG. 16. The electrode-applied voltages Vpixel of +1V, −3V, +3V, +3V, 0V, +6V, +6V, +4V, 0V, −6V, −6V, −3V, +3V, +3V, +1V, −3V, +3V, +3V, and 0V are respectively applied to the tenth to twenty-eighth pattern electrodes 13 not illustrated in FIG. 16.

With respect to the first to ninth pattern electrodes 13 shown in FIG. 16, the inter-electrode voltages VLC of 0V, 2V, 4V, 6V, 0V, 3V, 6V, and 0V, are respectively generated between: the first and second pattern electrodes 13; the second and third pattern electrodes 13; the third and fourth pattern electrodes 13; the fourth and fifth pattern electrodes 13; the fifth and sixth pattern electrodes 13; the sixth and seventh pattern electrodes 13; the seventh and eighth pattern electrodes 13; and the eighth and ninth pattern electrodes 13. With respect to the tenth to twenty-eighth pattern electrodes 13 that are not illustrated in FIG. 16, the inter-electrode voltages VLC of 2V, 4V, 6V, 0V, 3V, 6V, 0V, 2V, 4V, 6V, 0V, 3V, 6V, 0V, 2V, 4V, 6V, and 0V are respectively generated between: the ninth and tenth pattern electrodes 13; the tenth and eleventh pattern electrodes 13; the eleventh and twelfth pattern electrodes 13; the twelfth and thirteenth pattern electrodes 13; the thirteenth and fourteenth pattern electrodes 13; the fourteenth and fifteenth pattern electrodes 13; the fifteenth and sixteenth pattern electrodes 13; the sixteenth and seventeenth pattern electrodes 13; the seventeenth and eighteenth electrodes 13; the eighteenth and nineteenth pattern electrodes 13; the nineteenth and twentieth pattern electrodes 13; the twentieth and twenty-first pattern electrodes 13; the twenty-first and twenty-second pattern electrodes 13; the twenty-second and twenty-third pattern electrodes 13; the twenty-third and twenty-fourth pattern electrodes 13; the twenty-fourth and twenty-fifth pattern electrodes 13; the twenty-fifth and twenty-sixth pattern electrodes 13; the twenty-sixth and twenty-seventh pattern electrodes 13; and twenty-seventh and twenty-eighth pattern electrodes 13. As a result, a first grating pitch is realized by a combination of the inter-electrode voltages VLC of 0V, 2V, 4V and 6V, and a second grating pitch is realized by a combination of the inter-electrode voltages VLC of 0V, 3V, and 6V. Since the numbers of the first and second inter-electrode voltages are four and three, respectively, the repeating cycle of the inter-electrode voltages VLC is seven. Therefore, a blazed-type diffraction grating with a first grating pitch that is four times the electrode pitch (N=4) and a second grating pitch that is three times the electrode pitch (N=3) is formed by repeating the inter-electrode voltages VLC of 0V, 2V, 4V, 6V, 0V, 3V, and 6V for every seven pattern electrodes 13.

Thus, in the example shown in FIGS. 16 and 17, the electrode-applied voltages Vpixel are generated by the driving circuit 20 such that the electrode-applied voltages Vpixel are repeated in a cycle that is twice the sum of the numbers of the first and second inter-electrode voltages (repeating cycle of the inter-electrode voltages VLC) in a substrate-parallel direction (more particularly, in an electrode-orthogonal direction). Specifically, since the repeating cycle is seven, the electrode-applied voltages Vpixel of +6V, +6V, +4V, 0V, −6V, −6V, −3V, +3V, +3V, +1V, −3V, +3V, +3V, and 0V are repeated for every fourteen pattern electrodes 13.

### 3.2 Effects

According to the present embodiment, it is possible to form a blazed-type diffraction grating with two types of grating pitches. Additionally, in the same manner as Embodiment 2, the electrode-applied voltages Vpixel are repeated in a fixed cycle, or, more particularly, in a cycle that is twice the sum of the numbers of the first and second inter-electrode voltages (repeating cycle). This reduces the amount of information indicating the electrode-applied voltage Vpixel to be transmitted in a control signal to the driving circuit 20, which generates the electrode-applied voltage Vpixel. Since this shortens the transmission time of the control signal, it is possible to increase the speed of driving the liquid crystal diffraction element 10.

### 4. Others

In addition, it is possible to implement the present invention by modifying each of the aforementioned embodiments in various ways without departing from the spirit of the present invention. For example, while a reference voltage of 0V is applied to at least one of the plurality of pattern electrodes 13 in each of the aforementioned embodiments, it is also possible to not apply a reference voltage of 0V to any one of the plurality of pattern electrodes 13. Additionally, while the reference voltage is set to 0V in each of the embodiments above, it is also possible to use a voltage other than 0V as a reference voltage.

In the aforementioned Embodiment 3, it is not always necessary that the electrode-applied voltages Vpixel be repeated in a cycle that is twice the repeating cycle. Additionally, in the aforementioned Embodiment 3, there can be three types of grating pitches. In that case, too, the repeating cycle of the inter-electrode voltages VLC is the sum of the numbers of inter-electrode voltages respectively achieving each type of grating pitch.

### INDUSTRIAL APPLICABILITY

The light deflection device according to the present invention can be used as a light deflection element with a naked eye 3-D display with which 3-D images can be enjoyed comfortably without glasses.

### DESCRIPTION OF REFERENCE CHARACTERS

10 liquid crystal diffraction element (light deflection element)

11a, 11b glass substrate (transparent substrate)

12 interlayer insulation film

13 pattern electrode (transparent electrode)

14 alignment film

15 liquid crystal layer (medium with an anisotropic refractive index)

20 driving circuit

100 light deflection device

VLC inter-electrode voltage

Vpixel electrode-applied voltage

1. A light deflection device equipped with a light deflection element and a driving circuit that drives said light deflection element;
wherein said light deflection element comprises:
a pair of transparent substrates;
a medium with an anisotropic refractive index sandwiched between said pair of transparent substrates and having a refractive index that changes due to an electro-optic effect; and
a plurality of transparent electrodes provided on one of said transparent substrates for generating an electric field in a direction parallel to said pair of transparent substrates;
wherein said driving circuit applies a positive voltage to at least one of the plurality of transparent electrodes while applying a negative voltage to at least another one of the plurality of transparent electrodes and causes inter-electrode voltages generated between respective adjacent transparent electrodes to change incrementally and periodically across the plurality of transparent electrodes.

2. The light deflection device according to claim 1, wherein said driving circuit generates voltages to be respectively applied to said plurality of transparent electrodes such that said inter-electrode voltages vary incrementally and periodically across the plurality of transparent electrodes in said parallel direction in accordance with a prescribed sequence of voltages.

3. The light deflection device according to claim 2, wherein said driving circuit repeats the voltages to be respectively applied to said plurality of transparent electrodes in a period that is twice the total number of inter-electrode voltages constituting said prescribed sequence of voltages.

4. The light deflection device according to claim 1, wherein said driving circuit generates voltages to be respectively applied to said plurality of transparent electrodes such that said inter-electrode voltages vary incrementally and periodically across the plurality of transparent electrodes in said parallel direction in accordance with a plurality of prescribed sequences of voltages.

5. The light deflection device according to claim 4, wherein said driving circuit repeats the voltages to be respectively applied to said plurality of transparent electrodes in said parallel direction in a period that is twice the total number of the inter-electrode voltages constituting said plurality of prescribed sequences of voltages.

6. The light deflection device according to claim 1, wherein said driving circuit applies a same voltage to at least some of two mutually adjacent transparent electrodes among said plurality of transparent electrodes.

7. The light deflection device according to claim 1, wherein said driving circuit applies a ground voltage to some of the plurality of transparent electrodes.

8. A method of driving a light deflection element equipped with: a pair of transparent substrates, a medium with an anisotropic refractive index sandwiched between said pair of transparent substrates and having a refractive index that changes due to an electro-optic effect; and a plurality of transparent electrodes for generating an electric field in a direction parallel to said pair of transparent substrates, said method comprising:
applying voltages to the plurality of transparent electrodes, including:
applying a positive voltage to at least one of the transparent electrodes;
applying a negative voltage to at least another one of the transparent electrodes; and
generating inter-electrode voltages between respective adjacent transparent electrodes that vary incrementally and periodically across the plurality of transparent electrodes.

9. The method of driving according to claim 8, wherein said inter-electrode voltages vary incrementally and periodically across the plurality of transparent electrodes in said parallel direction in accordance with a prescribed sequence of voltages.

10. The method of driving according to claim 9, wherein the voltages to be respectively applied to said plurality of transparent electrodes are repeated in said parallel direction in a period that is twice the total number of inter-electrode voltages constituting said prescribed sequence of voltages.

11. The method of driving according to claim 8, wherein said inter-electrode voltages vary incrementally and periodically across the plurality of transparent electrodes in said parallel direction in accordance with a plurality of prescribed sequences of voltages.

12. The method of driving according to claim 11, wherein the voltages to be respectively applied to said plurality of transparent electrodes are repeated in said parallel direction in a period that is twice the total number of the inter-electrode voltages respectively constituting said plurality of prescribed sequences of voltages.

13. The method of driving according to claim 8, wherein a same voltage is applied to at least some of two mutually adjacent transparent electrodes among said plurality of transparent electrodes.

14. The method of driving according to claim 8, wherein a ground voltage is applied to some of the plurality of transparent electrodes.
